(19) United States
(12) Patent Application Publication
(10) Pub. No.: US 2023/0358195 A1
(43) Pub. Date: Nov. 9, 2023

(54) High-Pressure Fuel Pump for a Fuel Injection System of an Internal Combustion Engine

(71) Applicant: Robert Bosch GmbH, Stuttgart (DE)

(72) Inventors: Rainer Kornhaas, Stuttgart (DE); Stephan Wehr, Heiligenstadt (DE)

(21) Appl. No.: 18/044,984

(22) PCT Filed: Aug. 30, 2021
(86) PCT No.: PCT/EP2021/073827

§ 371 Date: Mar. 11, 2023

(30) Foreign Application Priority Data
Sep. 22, 2020 (DE) 10 2020 211 798.5

(51) Int. Cl. F02M 59/46; F02M 59/02

(52) U.S. Cl. CPC F02M 59/462; F02M 59/025

(57) ABSTRACT

A high-pressure fuel pump for a fuel injection system of an internal combustion engine is disclosed. The fuel pump includes a pump housing and a pump cover which is mounted on the pump housing and which, together with the pump housing, delimits a low-pressure chamber. A recess is formed in the pump housing, in which recess a pressure-limiting valve is located. The recess is fluidically connected to the low-pressure chamber via a channel. The channel has the same or a larger cross-section at its end facing the low-pressure chamber than at its end facing the recess.

### PRIOR ART

The invention relates to a high-pressure fuel pump for a fuel injection system of an internal combustion engine according to the preamble of claim 1.

Such a high-pressure fuel pump is known, for example, from DE 10 2018 211 237 A1. This high-pressure fuel pump has a pump housing and a pump cover mounted thereon with a low-pressure chamber. A pressure-limiting valve is arranged in a recess formed in the pump housing, wherein the recess is fluidically connected to a conveying chamber in which a piston runs. A further fuel pump is also known from DE 103 27 411 A1. Impermissible wear and cavitation erosion may occur at the pressure-limiting valve in such high-pressure fuel pumps.

### DISCLOSURE OF THE INVENTION

The underlying object of the invention is achieved by a high-pressure fuel pump having the features of claim 1. Advantageous developments of the invention are mentioned in the subclaims.

According to the present invention, a high-pressure fuel pump for a fuel injection system of an internal combustion engine is proposed, wherein the high-pressure fuel pump comprises a pump housing and a pump cover mounted on the pump housing (the pump cover possibly not being non-destructively detachable from the pump housing), which pump cover, together with the pump housing, delimits a low-pressure chamber. A recess is formed in the pump housing in which a pressure-limiting valve is arranged. The recess is fluidically connected via a channel to the low-pressure chamber, the channel having the same or a greater cross-section at its end facing the low-pressure chamber than at its end facing the recess with the pressure-limiting valve.

In this way, a connection of the pressure-limiting valve to the low-pressure chamber or the low-pressure damper of the high-pressure fuel pump arranged in the low-pressure chamber is achieved. This connection achieves that pressure pulsations/volume flows on the spring of the pressure-limiting valve can be reduced and wear and cavitation erosion at the pressure-limiting valve can thus be reduced. In addition, cavitation erosion can be avoided by steam in the conveying chamber as well as by the “breathing” of the valve body. Moreover, the stagnation pressures that arise in the event of a fault full conveyance in the high-pressure system may be reduced and the delivery level of the pump may be increased. The possible taper of the channel cross-section can possibly achieve acoustic advantages since the natural frequency of the recess can be modified thereby.

It has been recognized that in conventional high-pressure fuel pumps, wear can be caused by axial and radial movement of the spring receptacle as well as by “breathing” of the valve body due to alternating pressure build-up/reduction in the conveying chamber. It has further been recognized that cavitation erosion can be caused by opening the valve (due to the movement of the spring receptacle) and by steam produced in the suction phases in the conveying chamber. The movement of the spring receptacle may be caused by axial and radial oscillation of the spring due to pressure pulsations/volume flows in the conveying chamber. These points can be avoided with the proposed high-pressure fuel pump.

The present high-pressure fuel pump is in particular a piston pump. Such a pump has a conveying chamber and a piston which is arranged therein and may be oscillatingly driven.

The channel fluidically connecting the recess to the low-pressure chamber is formed in a wall of the pump housing that delimits the low-pressure chamber toward the pump housing and separates the low-pressure chamber from the recess. The channel may extend along a central longitudinal direction, in particular in a straight line. The recess is fluidically connected to an outlet of the high-pressure fuel pump (i.e., to the high-pressure side), on which outlet a connecting flange can, for example, be provided. Parallel to the pressure-limiting valve, an exhaust valve may be arranged.

The pressure-limiting valve may have a plurality of functions. On the one hand, the pressure-limiting valve may ensure that the pressure in the rail does not exceed a set value (e.g., during pressure overshoots or during hot shutdown). This ensures that the permissible load on the affected components is not exceeded. As long as the pressure in the rail is below the maximum permissible value, the pressure-limiting valve must seal against the low-pressure system or conveying chamber in order to prevent a pressure drop in the rail. The pressure-limiting valve may comprise a valve body, a ball, a spring receptacle, and/or a spring.

According to a development, the central longitudinal axis of the channel and the central longitudinal axis of the low-pressure chamber and/or the central longitudinal axis of the pump housing may be arranged parallel to one another or congruent to one another. As a result, a central arrangement of the channel with respect to the pump housing or the low-pressure chamber can be achieved. This helps to provide a good connection of the pressure-limiting valve to the low-pressure damper. Pressure pulsations at the pressure-limiting valve and movements of the spring of the pressure-limiting valve may be reduced again.

According to a development, the cross-section of the channel may increase conically along the central longitudinal axis of the channel toward the low-pressure chamber. Acoustic advantages can thus be achieved since the natural frequency of the recess can be modified thereby.

According to a development, the channel may have a first axial channel portion and a second axial channel portion, the second channel portion facing the low-pressure chamber and having a larger cross-section than the first channel portion. The excitation of the vibrations can thus also be dampened so that acoustic advantages can be achieved. In other words, the channel is designed as a stepped channel, e.g., a stepped bore, which widens toward the low-pressure chamber or whose larger cross-section (e.g., larger diameter) faces the low-pressure chamber.

According to a development, a conveying chamber in which a piston runs can be provided, wherein the wall separating the conveying chamber and the recess in which the pressure-limiting valve is arranged is channel-free. This contributes to a good connection of the pressure-limiting valve to the low-pressure chamber or the low-pressure damper arranged in the low-pressure chamber. There is no direct flow connection from the conveying chamber to the recess via the wall.

According to a development, the central longitudinal axis of the recess for the pressure-limiting valve may be oriented orthogonally to the central longitudinal axis of the pump housing. This contributes to a compact design of the high-pressure fuel pump since a low design height can be achieved.

Possible embodiments of the invention are explained below with reference to the accompanying drawings, wherein identical or functionally identical elements are provided with identical reference signs. Shown are:

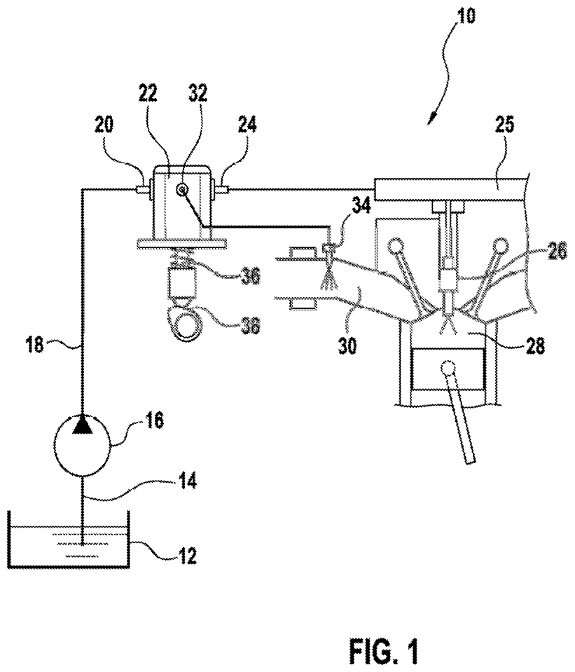

FIG. 1 a schematic illustration of a fuel system for an internal combustion engine; and

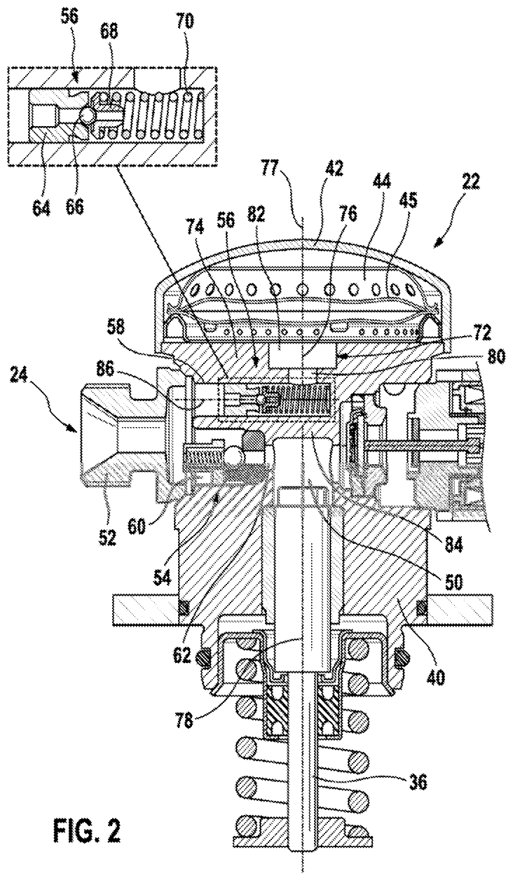

FIG. 2 an embodiment of the high-pressure fuel pump in a longitudinal section.

FIG. 1 shows a fuel injection system 10 for an internal combustion engine in a schematic illustration. From a fuel tank 12, fuel is supplied via a suction line 14 by means of a pre-feed pump 16 into a low-pressure line 18 and from there to a low-pressure connection 20 (inlet 20) of a high-pressure fuel pump 22.

A fuel, e.g., gasoline, is compressed to a high pressure in the high-pressure fuel pump 22 and supplied to a combustion chamber 28 of the internal combustion engine through a high-pressure connection 24 (outlet 24) via a high-pressure rail 25 and a high-pressure injector 26. There, the fuel can be mixed with air supplied via a suction tube 30 and can be ignited, e.g., by a spark generated with a spark plug.

Optionally, a portion of the fuel supplied via the low-pressure connection 20 of the high-pressure fuel pump 22 may be guided out of the high-pressure fuel pump 22 again through a further low-pressure connection 32 after a flow through the high-pressure fuel pump 22 without compression, and into the suction tube 30 via a low-pressure injector 34. There, this portion of the fuel may mix with the supplied air before the mixture enters the combustion chamber 28.

The high-pressure fuel pump 22 is embodied as a piston pump, wherein a piston 36 may be driven, for example, by way of a cam disk 38 (direction of motion is vertically oriented in the drawing).

The high-pressure fuel pump 22 is discussed in more detail below with reference to FIG. 2.

The high-pressure fuel pump 22 comprises a pump housing 40 on, at or in which the components of the high-pressure fuel pump 22 are arranged. In particular, a pump cover 42, which can be connected to the pump housing 40, e.g., welded, is mounted on the pump housing 40, in particular in a non-destructively detachable manner. The pump cover 42, together with the pump housing 40, delimits a low-pressure chamber 44. A low-pressure damper 45 is arranged in the low-pressure chamber 44.

On the side of the pump housing 40, a connection nozzle (inlet nozzle) (not shown in FIG. 2) is mounted on the inlet 20. The inlet 20 or the inlet-side connection nozzle is fluidically connected to the low-pressure chamber 44 via a connection channel (not shown). Through a further connection channel (not shown), the low-pressure chamber 44 is fluidically connected to the conveying chamber 50 in which the piston 36 is arranged. This can guide fuel from the low-pressure chamber 44 into the conveying chamber 50.

On the side of the pump housing 40, a connection nozzle 52 (outlet nozzle 52) is attached to the outlet 24. An exhaust valve 54 and a pressure-limiting valve 56 are also provided at the outlet 24. The pressure-limiting valve 56 is arranged in a recess 58 formed in the pump housing 40. The exhaust valve 54 is arranged in a recess 60 formed in the pump housing 40.

In the example, the recesses 58, 60 are oriented parallel to one another and are fluidically connected to the outlet 24 or the connection nozzle 52. The exhaust valve 54 is also fluidically connected to the conveying chamber 50 via a passage 62. The pressure-limiting valve 56 in particular consists of a plurality of components and may comprise, for example, a valve body 64, a ball 66, a spring receptacle 68, and/or a spring 70 (cf. enlarged section in FIG. 2).

The recess 58 in which the pressure-limiting valve 56 is arranged is fluidically connected to the low-pressure chamber 44 via a channel 72. The channel 72 is formed in a wall 74 of the pump body 40 that delimits the low-pressure chamber 44 toward the pump body 40 and separates the low-pressure chamber 44 from the recess 58.

The channel 72 extends along a central longitudinal axis 76, in particular, linearly. The channel 72 has the same or a greater cross-section at its end facing the low-pressure chamber 44 than at its end facing the recess 58 with the pressure-limiting valve 56.

In the example, the central longitudinal axis 76 of the channel 72 and the central longitudinal axis 77 of the low-pressure chamber 44 and/or the central longitudinal axis 78 of the pump housing 40 are arranged parallel to one another or congruent to one another.

In the example, the channel 72 has a first axial channel portion 80 and a second axial channel portion 82, wherein the second channel portion 82 faces the low-pressure chamber 44 and has a larger cross-section than the first channel portion 80. In the example, the channel 72 is formed as a stepped channel in the form of a stepped bore that widens toward the low-pressure chamber 44 (smaller diameter in the first channel portion 80 than in the second channel portion 82). In non-illustrated embodiments, the cross-section of the channel 72 may conically increase along the central longitudinal axis 76 of the channel 72 toward the low-pressure chamber 44.

The conveying chamber 50 in which the piston 36 runs is separated by way of a wall 84 from the recess 58 in which the pressure-limiting valve 56 is arranged. The wall 84 is channel-free. In other words, there is no direct flow connection between the conveying chamber 50 and the recess 58 through the wall 84.

The central longitudinal axis 86 of the recess 58 for the pressure-limiting valve 56 is oriented orthogonally to the central longitudinal axis 78 of the pump housing 40.

As a result of an upward movement of the piston 36, the medium (fuel) located in the conveying chamber 50 is displaced and conveyed, for example to a high-pressure rail 25, via the exhaust valve 54, which opens away from the conveying chamber 50, and via the outlet 24 or the connection nozzle 52. The pressure-limiting valve 56 is actuated anti-parallel to the exhaust valve 54 (opposite opening direction) in order to prevent impermissibly high pressures in the high-pressure area of the fuel system 10.

1. A high-pressure fuel pump for a fuel injection system of an internal combustion engine, comprising:
a pump housing; and
a pump cover which is mounted on the pump housing and which, together with the pump housing, delimits a low-pressure chamber,
wherein a recess is formed in the pump housing, in which recess a pressure-limiting valve is arranged,
wherein the recess is fluidically connected to the low-pressure chamber via a channel, and
wherein the channel has the same or a larger cross-section at its end facing the low-pressure chamber than at its end facing the recess.

2. The high-pressure fuel pump according to claim 1, wherein the central longitudinal axis of the channel and the central longitudinal axis of the low-pressure chamber and/or the central longitudinal axis of the pump housing are arranged parallel to one another or congruent to one another.

3. The high-pressure fuel pump according to claim 1, wherein the cross-section of the channel conically increases along the central longitudinal axis of the channel toward the low-pressure chamber.

4. The high-pressure fuel pump according to claim 1, wherein:
the channel has a first axial channel portion and a second axial channel portion, and
the second channel portion faces the low-pressure chamber and has a larger cross-section than the first channel portion.

5. The high-pressure fuel pump according to claim 1, further comprising a conveying chamber, in which a piston runs,
wherein the wall separating the conveying chamber and the recess is channel-free.

6. The high-pressure fuel pump according to claim 1, wherein the central longitudinal axis of the recess for the pressure-limiting valve is oriented orthogonally to the central longitudinal axis of the pump housing.
